(19) United States
(12) Patent Application Publication
(10) Pub. No.: US 2022/0334545 A1
(43) Pub. Date: Oct. 20, 2022

(54) Wireless Irrigation Clock System Operable With a Mesh Network

(71) Applicants: James Hobbs, Hobe Sound, FL (US); Clouse Hobbs, Hobe Sound, FL (US)

(72) Inventors: James Hobbs, Hobe Sound, FL (US); Clouse Hobbs, Hobe Sound, FL (US)

(21) Appl. No.: 17/233,390

(22) Filed: Apr. 16, 2021

(51) Int. Cl. G05B 19/042; G06F 1/04

(52) U.S. Cl. CPC G05B 19/042; G06F 1/04; G05B 2219/2625

(57) ABSTRACT

A wireless irrigation clock system that operates through a mesh network is configured to program functions that control one or more irrigation controls across multiple agricultural zones. The functions are transmitted over the mesh network as a command signal to corresponding irrigation controls. The clock can, for example, be programmed to generate command signals that control the timing and amount of water discharged through solenoid valves. Multiple relay signal repeaters transmit the command signal through the mesh network to appropriate irrigation controls. The relay signal repeaters are arranged to overcome long distances and barriers. The command signal can include instructions to program the time and amount of water discharged through a pump or a booster pump; or the open and closed position of a solenoid valve. A switch operatively connects to the clock to receive the valve command signals to control the irrigation controls, in correspondence to the command signals.

### FIELD OF THE INVENTION

The present invention relates generally to a wireless irrigation clock system operable with a mesh network. More so, the present invention relates to an irrigation clock that programs parameters for multiple irrigation controls, and transmits command signals to the irrigation controls through a mesh network.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, agricultural propagation is possible in soil that has been watered by rain. However, normal and healthy growth of vegetation can be retarded and even prevented when natural rainfall fails to meet the requirements of that vegetation. Thus, it is known in the art to employ artificial irrigation to compensate for the deficiencies of nature by supplying sufficient amounts of water directly to vegetation at predetermined intervals for predetermined lengths of time.

Irrigation systems typically include valves, controllers, pipes, and emitters such as sprinklers or drip tapes. Irrigation systems are usually divided into zones based on the spatial resolution of the detection system, and irrigation is performed on that zone based on reflection from all the crop plants within that zone. Each zone may have a solenoid valve controlled via irrigation control opening or closing irrigation zones. The irrigation control may be a mechanical or electrical device signaling a zone to turn start irrigating a section of crop for a specific amount of time, or until it is turned off manually.

Prior art irrigation clocks, or irrigation controls, have included automatic electromechanical controllers that are conventional motor-driven electric clocks for allowing a user to program individual start times for particular irrigation cycles and watering stations. Calendar programs could provide the ability to select particular days for watering over a span of 14 days and more. With these electromechanical controllers, calendar programs would be operable by means of a disc that is rotated each 24 hours to a next-day position by a motor-driven clock. Unfortunately, such systems quickly become undesirably complex with increased numbers of watering zones, such as is required with golf courses, cemeteries, parks, and the like.

Additional prior art clocks provided solid state irrigation controls that replaced electric motors, mechanical switches, actuating pins, cams, levers, gears, and other mechanical devices with solid state electronic circuitry. With this, the systems allow programming of multiple start times and day programs for individual watering stations or zones, repeat cycles, and watering time selections in minutes or even seconds. This is possible with increased accuracy coupled with a concomitant elimination of the complex interrelation of mechanical parts.

It is also known that there solid-state clocks were not always wireless, requiring much cable and labor to install. However, due to the complexity of these irrigation controls, the homeowner, after the irrigation control is initially installed, makes few if any changes to the irrigation control settings and may not even check, if the irrigation control is operating properly unless the landscape plant material begins browning and/or dying.

It is known in the art that Z-Wave is based on a mesh network topology. This means each (non-battery) device installed in the network becomes a signal repeater. Z-Wave is a wireless home automation protocol that operates in the 908.42 MHz frequency band. One of the features of Z-Wave is that it utilizes a type of network known as a “mesh network,” which means that one Z-Wave device will pass a data frame along to another Z-Wave device in the network until the data frame reaches a destination device. As a result, Z-Wave signals easily travel through most walls, floors and ceilings, the devices can also intelligently route themselves around obstacles to attain seamless, robust coverage.

Generally, Z-Wave has a range of 100 meters or 328 feet in open air, building materials reduce that range, it is recommended to have a Z-Wave device roughly every 30 feet, or closer for maximum efficiency. The Z-Wave signal can hop roughly 600 feet, and Z-Wave networks can be linked together for even larger deployments. Each Z-Wave network can support up to 232 Z-Wave devices provides the flexibility to add as many devices to the network.

Often, the Z-Wave network comprises a primary hub controller and at least one controllable device, known as a slave node, or more simply, a “node.” The controller establishes the Z-Wave network. The controller is the only device in a Z-Wave network that determines which Z-Wave nodes belong to the network. The primary hub controller is used to add or remove nodes from the network. The process of adding or removing nodes, also known as inclusion/exclusion, requires that the controller must be within direct radio frequency (RF) range of the node that is to be added or deleted from the network.

Other proposals have involved irrigation clocks for controlling pumps, solenoid valves, sensors, and other irrigation equipment. The problem with these irrigation clocks is that they do not utilize a flexible wireless communication system, such as Z-wave. Also, the irrigation clocks cannot be controlled for powering on and restricting specific zones in the field. Even though the above cited irrigation clocks meet some of the needs of the market, a wireless irrigation clock system operable with a mesh network that programs parameters for multiple irrigation controls, and transmits command signals to the irrigation controls through a mesh network, is still desired.

### SUMMARY

Illustrative embodiments of the disclosure are generally directed to a wireless irrigation clock system that operates through a mesh network is configured to program functions that control one or more irrigation controls across agricultural zones. The functions are transmitted over the mesh network as a command signal to corresponding irrigation controls. The clock can, for example, be programmed to generate command signals that control the timing and amount of water discharged through solenoid valves. Further, the clock may include multiple LED's having a unique illumination, with each illumination indicating the status of a faulty or operational irrigation control. Multiple relay signal repeaters transmit the command signal through the mesh network to the appropriate irrigation control. The relay signal repeaters are arranged to overcome long distances and barriers. The command signal can include instructions to program the time and amount of water discharged through a pump or a booster pump; or the open and closed position of a solenoid valve. A switch operatively connects to the clock to receive the valve command signals to control the irrigation controls, in correspondence to the command signals.

In one aspect, a wireless irrigation clock system, comprises:
a clock comprising a housing having a display and multiple switches configured to receive input for an irrigation command, the irrigation command operable to control one or more functions of one or more irrigation controls,
the clock operable to generate one or more command signals based on the inputted irrigation command, the command signals operable to actuate the functions of the irrigation controls, the clock operable to transmit the command signals over a mesh network,
the clock further comprising a housing, the housing containing a transreceiver, a real time clock, a microcontroller, and a circuitry, the transreceiver configured to receive and transmit the command signals, the real time clock configured to track both time and date; and
multiple relay signal repeaters operable to carry the command signals across the mesh network.

In a second aspect, the housing is waterproof.

In another aspect, the housing has a small, rectangular profile.

In another aspect the housing has dimensions up to 6 inches in length, 3 inches in width, and 2 inches in thickness.

In another aspect, the switches include at least one of the following: a button, a toggle switch, and a dial.

In another aspect, the clock comprises multiple LED's having a unique illumination, each illumination indicating the status of a faulty or operational irrigation control.

In another aspect, the one or more irrigation controls comprise a solenoid valve.

In another aspect, the functions of the irrigation controls comprise the open and closed positions of the solenoid valve.

In another aspect, the one or more irrigation controls comprise a pump, or a booster pump, or both.

In another aspect, the functions of the irrigation controls comprise the timing and amount of water discharged through the pump and the booster pump.

In another aspect, the system is operable across multiple agricultural zones.

In another aspect, the relay signal repeaters are operatively disposed across the agricultural zones for transmitting the command signals through the mesh network to the irrigation controls.

In another aspect, the clock comprises multiple channels corresponding to the agricultural zones.

In another aspect, the clock comprises a rechargeable battery.

In another aspect, the mesh network includes at least one following networks: a Z-wave network, a Zigbee network, a packet radio network, a thread network, an Smash network, a SolarMESH project network, and a WiBACK wireless technology network.

In another aspect, the system further comprises a switch operatively connected to the one or more irrigation controls, the switch operable to receive the valve command signals, the switch operable to control the one or more irrigation controls in correspondence to the valve command signals.

One objective of the present invention is to provide an irrigation clock that wirelessly transmits command signals to one or more irrigation controls over a mesh network.

A still further object of the invention is to provide an irrigation clock that guides a user through the programming process by providing an indication of presently selected altering zones and, possibly, programming functions.

Additional objectives are to provide a mesh network that operates the clock and the irrigation controls.

An exemplary objective is to position the relay signal repeaters strategically around multiple agricultural zones, so as to optimize the mesh network.

Additional objectives are to provide a strong signal, even with walls, fences, and barriers segregating the agricultural zones.

Yet another objective is to make the assembly portable over different types of agricultural and non-agricultural environments.

Another objective of the irrigation clock is to receive faulty messages from the irrigation controls for determining repair and maintenance of the irrigation control.

Another objective is to minimize the charging requirements of the clock through use of a long-lasting battery.

Yet another objective is to provide an inexpensive to manufacture wireless irrigation clock.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIGS. 1A-1B illustrates views of an exemplary wireless irrigation clock system, showing the clock. where FIG. 1A shows a front perspective view, and FIG. 1B shows a rear perspective view, in accordance with an embodiment of the present invention;

FIG. 2 illustrates a block diagram of an exemplary Z-wave network, in accordance with an embodiment of the present invention;

FIG. 3 illustrates a frontal view of the clock shown in FIG. 1A, in accordance with an embodiment of the present invention;

FIG. 3 illustrates a frontal view of the clock shown in FIG. 1A, in accordance with an embodiment of the present invention;

FIG. 4 illustrates a rear view of the clock shown in FIG. 1A, in accordance with an embodiment of the present invention;

FIG. 5 illustrates a front perspective view of an exemplary irrigation solenoid valve switch assembly operable on a mesh network across multiple agricultural zones, in accordance with an embodiment of the present invention;

FIG. 6 illustrates a sectioned view of a housing for the clock, showing electrical components that enable the clock to operate irrigation controls, in accordance with an embodiment of the present invention; and

FIG. 7 illustrates a block diagram depicting an exemplary client/server system which may be used by an exemplary web-enabled/networked embodiment, in accordance with an embodiment of the present invention.

Like reference numerals refer to like parts throughout the various views of the drawings.

### DETAILED DESCRIPTION OF THE INVENTION

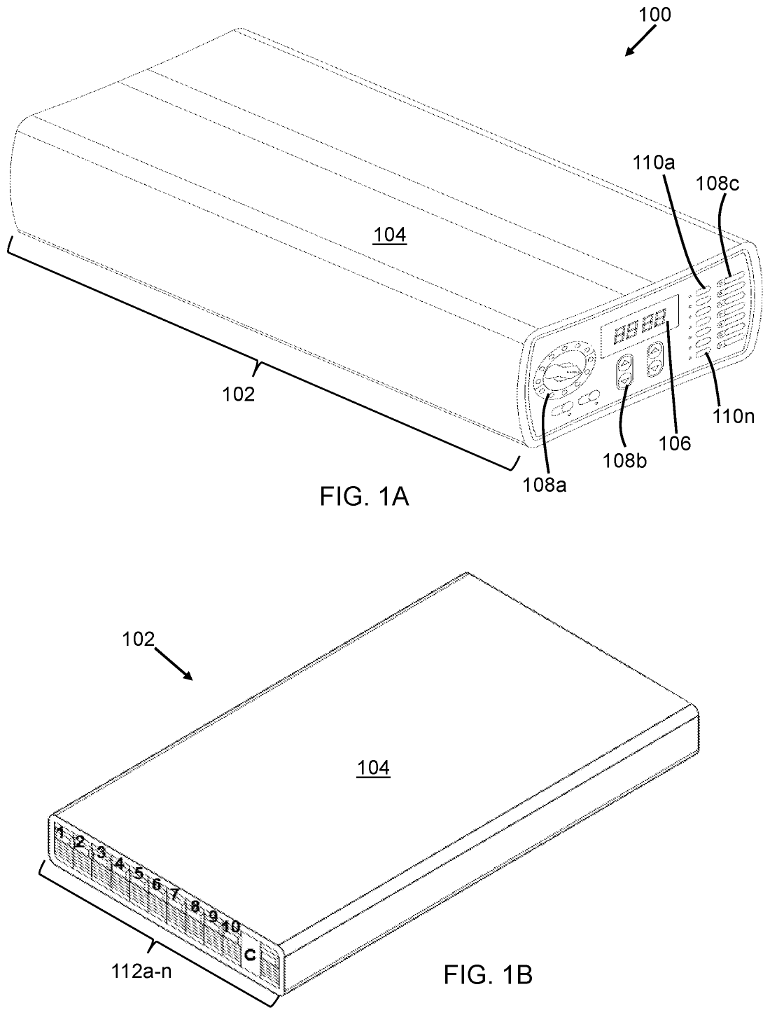

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1A. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

FIG. 1A references a wireless irrigation clock system 100. The wireless irrigation clock system 100, hereafter “system 100” provides a unique clock 102, or irrigation control, designed to wirelessly control irrigation control mechanisms across multiple agricultural zones. The clock 102 is programmed with commands and transmits command signals 500 through a mesh network 200 that provide a long-reaching signal that carries across large fields, walls, fences, and barriers segregating the agricultural zones 504a-c.

In some embodiments, system 100 comprises a clock 102 that operates through a mesh network. The clock 102 is configured to program functions that control one or more irrigation controls 506a-c across the agricultural zones 504a-c. The functions are transmitted over the mesh network 200 as a command signal 500 to corresponding irrigation controls 506a-c. The clock 102 can, for example, be programmed to generate command signals 500 that control the timing and amount of water discharged through solenoid valves. Further, the clock 102 may include multiple LED's having a unique illumination, with each illumination indicating the status of a faulty or operational irrigation control.

To enhance the mesh network 200, multiple relay signal repeaters 510a, 510b, 510c transmit the command signal through the mesh network 200 to the appropriate irrigation control. The relay signal repeaters are arranged to overcome long distances and barriers. The command signal 500 can include instructions to program the time and amount of water discharged through a pump or a booster pump; or the open and closed position of a solenoid valve. One or more switches 508a-c operatively connects to the irrigation controls 506a-c to receive the valve command signals 500 from clock 102 in order to control the irrigation controls 506a-c, in correspondence to the command signals 500.

Turning to FIG. 1A, system 100 comprises a clock 102, or irrigation control. The clock 102 is configured to automatically make adjustments to the irrigation run times to account for daily environmental variations. The clock 102 is also configured to identify the faulty or operational status of the irrigation controls 506a-c. As illustrated, the clock 102 comprises a housing 104. Since the clock 102 operates outside, in an agricultural environment, the housing 104 is waterproof. This helps protect against moisture, wind, and contaminants. As FIG. 1B illustrates, the housing 104 has a small, rectangular profile. In one non-limiting embodiment, the housing 104 has dimensions up to 6″ in length, 3″ in width, and 2″ in thickness. However, other dimensions may also be used. The simplicity of the clock 102 allows it to be universally adapted to numerous types of irrigation controls 506a-c and mesh networks 200.

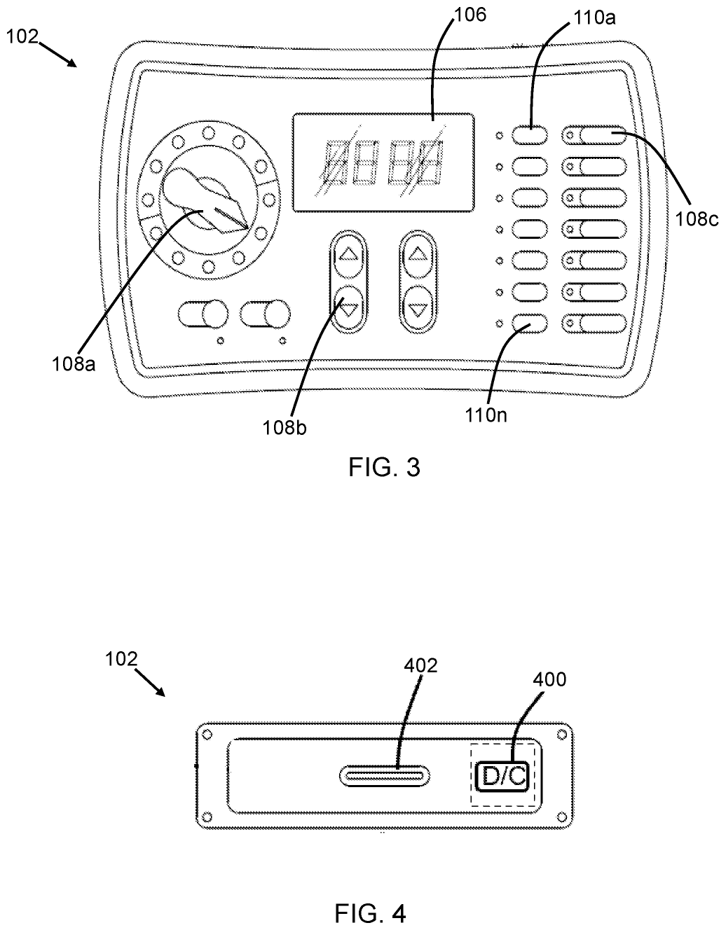

Looking ahead to FIG. 3, the housing 104 contains multiple switches 108a, 108b, 108c configured to receive input for an irrigation command. Such an irrigation command is configured to control one or more functions of one or more irrigation controls 506a-c. In one non-limiting embodiment, the switches 108a-c operate the time and date that the pumps and solenoid valves are opened. For example, every Tuesday at 7:00 am, the pumps discharge water, and the solenoid valves move to the open position.

In some embodiments, the switches 108a-c include at least one of the following: a button, a toggle switch, and a dial. Additionally, the housing 104 has a display 106 for viewing the irrigation command, or a time period. In other embodiments, the clock 102 comprises a rechargeable battery. The battery 400 can be charged with a D/C power source through a charging port 402 or USB port, as shown in FIG. 4. In one example, a D/C source of energy to charge/recharge the battery 400 includes a solar panel.

In some embodiments, the clock 102 is configured to generate one or more command signals 500 that are based on the inputted irrigation command. Thus, as a user clicks buttons or dials to set a timer or period for irrigating a zone with the irrigation controls 506a-c, a corresponding command signals 500 is generated by the clock 102. In this manner, the command signals 500 are operable to actuate the functions of the irrigation controls 506a-c. In one embodiment, the command signal 500 may include a radio frequency wave, or low-energy radio waves to communicate between signal repeaters, for example.

In one embodiment, the clock 102 is configured to transmit the command signals 500 over a mesh network. The mesh network is operable over multiple agricultural zones for controlling one or more irrigation controls 506a-c thereon. In some embodiments, the clock 102 comprises multiple channels 112a-n corresponding to the agricultural zones. Thus, if a channel 112a is opened, communication to that zone is allowed. And if a channel 112n is closed, communication to that zone is restricted. In this manner, the user can selectively control the irrigation controls 506a-c.

In this manner, the channels can be integrated or disconnected to selectively enable the solenoid valve to discharge or restrict water for the corresponding agricultural zone. For example, a channel #3 can be turned off to restrict communications between the clock 102 and the switch 508a-c for the solenoid valve in zone #3. Or, channels 1-4 can be turned on to initiate communications between the clock 102 and the switches and coupled solenoid valves in agricultural zones 1-4. The channels can be manually switched on or off to enable or disable communications. This may include opening and closing a circuit for a transreceiver in the clock 102; whereby the circuitry regulates the transreceiver.

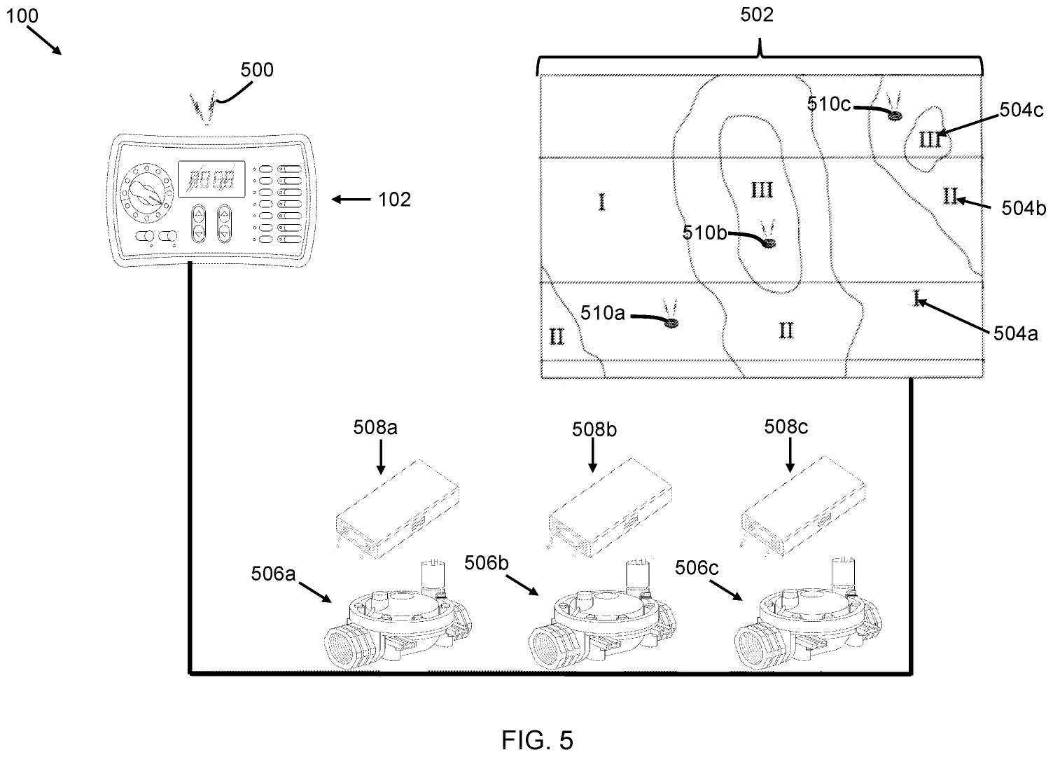

As shown in the field view of FIG. 5, the one or more irrigation controls 506a-c comprise a solenoid valve. In this configuration, the functions of the irrigation controls 506a-c comprise the open and closed positions of the solenoid valve. In other embodiments, the one or more irrigation controls 506a-c comprise a pump, or a booster pump, or both. In this configuration, the functions of the irrigation controls 506a-c comprise the timing and amount of water discharged through the pump and the booster pump. However, other irrigation controls 506a-c, such as sensors, timers, and the like may also be used. Those skilled in the art will recognize that such irrigation controls 506a-c are operable in an agricultural field 502 across multiple zones 504a, 504b, 504c.

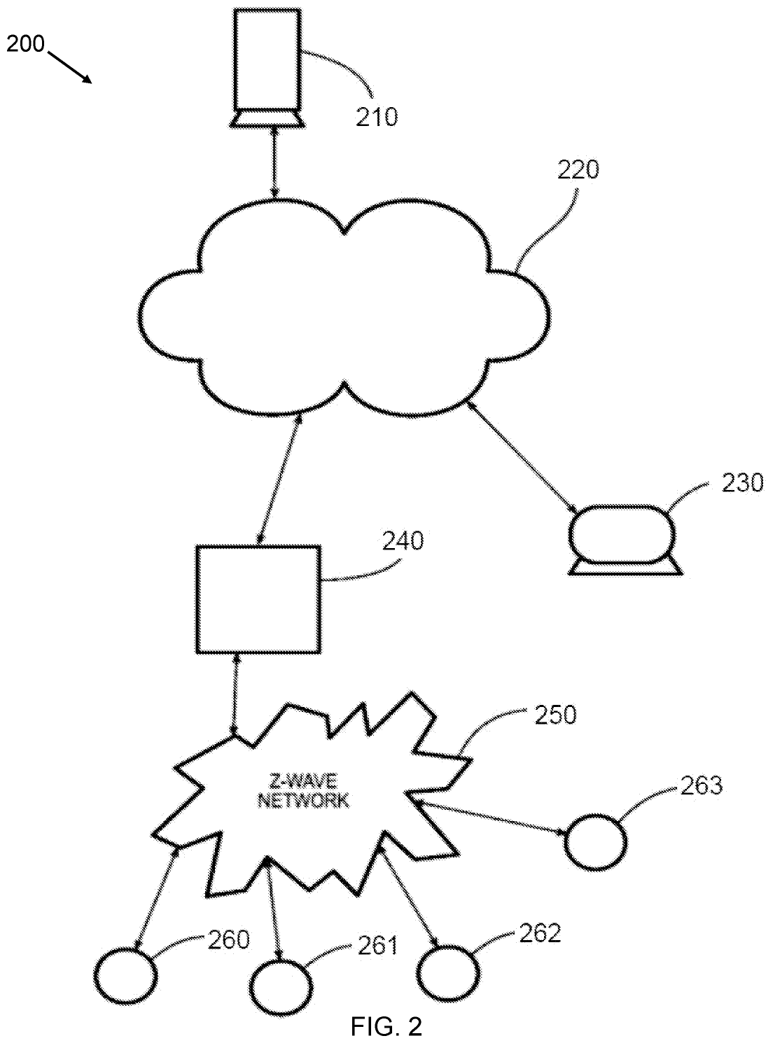

As referenced in FIG. 2, a primary operational function of the system is the operation of irrigation valves and pumps over long distances in an agricultural environment, and over multiple agricultural zones, through use of a mesh network 200. In some embodiments, the mesh network may include, without limitation: a Z-wave network, a Zigbee network, a packet radio network, a thread network, an Smash network, a SolarMESH project network, and a WiBACK wireless technology network.

The system 100 uses the mesh network 200 to transmit valve commands that control the timing and amount of water discharged through a solenoid valve in multiple agricultural zones. The mesh network 200 may include, without limitation, a Z-wave network, a Zigbee network, a packet radio network, a thread network, a Smash network, a SolarMESH project network, and a WiBACK wireless technology network. By utilizing a mesh network 200, greater distances may be covered across fields, or other environments in which assembly may be operable.

In one non-limiting embodiment, the mesh network 200 is a Z-wave wireless communication protocol that comprises of low-energy radio waves to communicate between signal repeaters, i.e., relay points, across the zones. The Z-wave network can be controlled via the Internet with intercommunication between multiple relay points positioned throughout the agricultural zones. As shown in schematic diagram of a mesh network 200, a Z-wave wireless communication protocol forms a Z-wave network 250. The Z-wave network 250 enables communications in the zones. It is known in the art that the Z-wave network 250 comprises a mesh network defined by low-energy radio waves. The Z-wave network 250 comprises of a mesh network of low-energy radio waves to communicate between signal repeaters, i.e., relay points, across the zones.

The Z-wave network 250 can be controlled via the Internet with intercommunication between multiple relay points positioned throughout the zones. In some embodiments, the Z-wave network 250 may also include an Internet Wi-Fi transceiver. The Z-wave network 250 may also include multiple signal repeaters that are operatively disposed across the zones. In other embodiments, the signal repeaters are operatively disposed between tables and across walls in the zones. Those skilled in the art will recognize that the numerous fences, trees, and hills in a field require a mesh network to optimize communications between switches and solenoid valves in which infrastructure nodes, i.e., bridges, switches, and other infrastructure devices, connect directly, dynamically, and non-hierarchically.

One exemplary mesh network is shown in a schematic diagram of the mesh network 200 (FIG. 2). The mesh network 200 includes Internet 220 and Z-wave network 250. As illustrated, a number of devices are in communication with each other over Internet 220, including a portal server 210, a user device 230 and a Z-wave networking device 240. User device 230 may communicate with portal server 210 through a web browser interface, using standard hypertext transfer protocol (HTTP). Further, a portal server 210 communicates with Z-wave networking device 140 through lower layer Internet protocols, such as Transmission Control Protocol/Internet Protocol (TCP/IP) or User Datagram Protocol/Internet Protocol (UDP/IP).

In yet other embodiments, Z-wave networking device 240 conducts radio frequency (RF) communications with Z-wave networking devices 260-263. It should be noted that some devices 260-263 may be in direct communication with Z-wave networking device 240. As Z-wave network 250 is a mesh network, some devices 260-263 may communicate with Z-wave networking device indirectly, through other devices 260, 261, 262, 263.

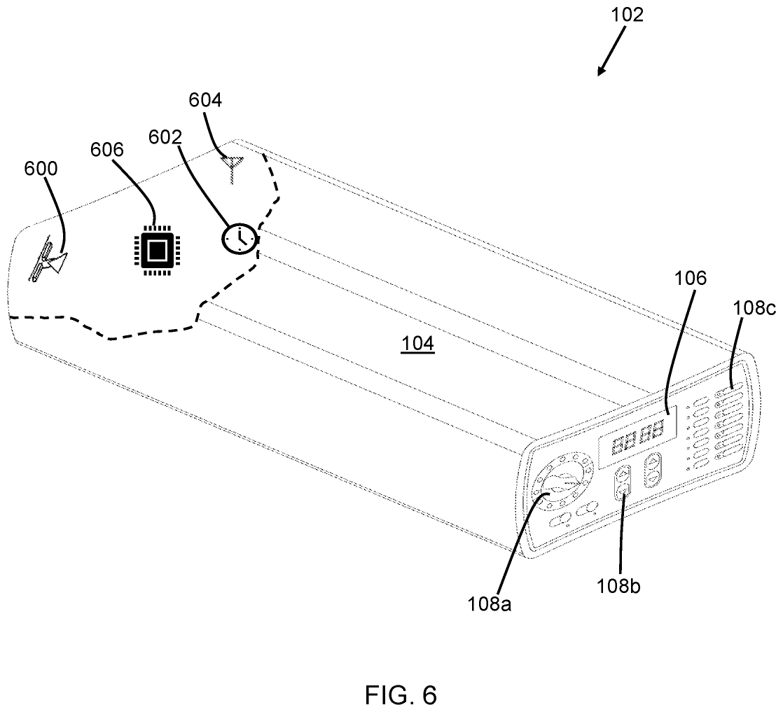

Turning now to FIG. 6, the housing 104 also contains electrical components that enable the clock to operate irrigation controls through commands, and transmit the command signals through the mesh network 200. The housing 104 contains a transreceiver 600, a real time clock 602, a microcontroller 604, and a circuitry 606. The transreceiver 600 is configured to receive and transmit the command signals 500. The real time clock 602 is configured to track both time and date. This timing and date feature can be used to program the pumps and solenoid valves for preprogrammed operation. The circuitry 606 may include, without limitation: wires, processors, resistors, and transistors that are necessary to operate clock, as is known in the art.

In some embodiments, the clock 102 comprises multiple LED's 110a-n having a unique illumination based on the status of the irrigation controls 506a-c. Each LED 110a, 110n illuminates to indicate the status of a faulty or operational irrigation control. For example, if a solenoid valve is nonoperational, a command signal is transmitted to the clock, where a red-light illuminate. Or if maintenance to a pump is required in ten days, a yellow light illuminates, and if in one day, a red light illuminates, for example.

To facilitate transmission of command signals between the clock 102 and the irrigation controls 506a-c, one or more switches 508a-c having transreceiver and various sensors may be coupled to the irrigation controls 506a-c. The switches 508a, 508b, 508c are operatively connected to the one or more irrigation controls 506a, 506b, 506c in order to receive the command signals 500 for operation of the irrigation control, or relaying a faulty or operational signal to the clock. In this manner, the switches 508a-c indirectly controls the irrigation controls in correspondence to the command signals 500.

In other embodiments, the clock 102 also comprises a processor, which may be operable with an algorithm. The algorithm in the processor is configured to calculate the timing of water discharge, and predetermined needs for specific plants. The processor is also configured to calculate the proximate position of the solenoid valves relative to each other, so as to optimize discharge of water onto the fields, and across the agricultural zones. In some embodiments, an algorithm, which is operable in clock, acts to regulate communications between the clock and the solenoid valve.

As discussed above, since the system 100 is operable with a mesh network 200, also provides multiple relay signal repeaters operable to carry the command signals across the mesh network. The relay signal repeaters are operatively disposed across the agricultural zones for transmitting the command signals through the mesh network to the irrigation controls. The relay signal repeaters 510a-c are arranged to overcome long distances and barriers across multiple agricultural zones. However, the zones 504a-c may also encompass non-agricultural irrigation-related areas, including, without limitation, golf courses, sports fields, gardens, green houses, buildings, malls, and the like.

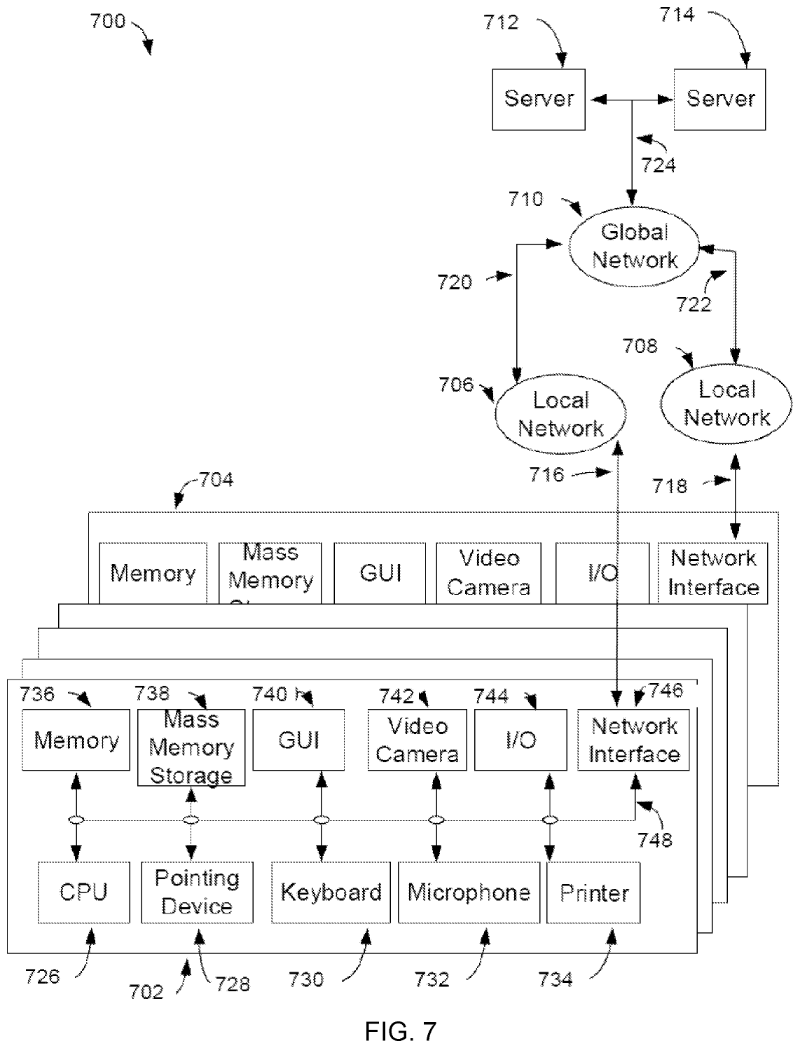

FIG. 7 is a block diagram depicting an exemplary client/server system which may be used by an exemplary web-enabled/networked embodiment of the present invention. A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones. Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

In conclusion, wireless irrigation clock system 100 operates through a mesh network 200 to program functions that control one or more irrigation controls across agricultural zones. The functions are transmitted over the mesh network as a command signal to corresponding irrigation controls. The clock can, for example, be programmed to generate command signals that control the timing and amount of water discharged through solenoid valves. Multiple relay signal repeaters transmit the command signal through the mesh network to the appropriate irrigation control. The relay signal repeaters are arranged to overcome long distances and barriers. The command signal can include instructions to program the time and amount of water discharged through a pump or a booster pump; or the open and closed position of a solenoid valve. A switch operatively connects to the clock to receive the valve command signals to control the irrigation controls, in correspondence to the command signals.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A wireless irrigation clock system, the system comprising:
a clock comprising a housing having a display and multiple switches configured to receive input for an irrigation command, the irrigation command operable to control one or more functions of one or more irrigation controls,
the clock operable to generate one or more command signals based on the inputted irrigation command, the command signals operable to actuate the functions of the irrigation controls, the clock operable to transmit the command signals over a mesh network,
the housing further having a transreceiver, a real time clock, a microcontroller, and a circuitry, the transreceiver configured to receive and transmit the command signals, the real time clock configured to track both time and date; and
multiple relay signal repeaters operable to carry the command signals across the mesh network.

2. The system of claim 1, wherein the housing is waterproof.

3. The system of claim 1, wherein the housing has a small, rectangular profile.

4. The system of claim 3, wherein the housing has dimensions up to 6 inches in length, 3 inches in width, and 2 inches in thickness.

5. The system of claim 1, wherein the multiple switches include at least one of the following: a button, a toggle switch, and a dial.

6. The system of claim 1, wherein the clock comprises multiple LED's having a unique illumination, each illumination indicating the status of a faulty or operational irrigation control.

7. The system of claim 1, wherein the clock comprises a rechargeable battery.

8. The system of claim 1, wherein the one or more irrigation controls comprise a solenoid valve.

9. The system of claim 8, wherein the functions of the irrigation controls comprise the open and closed positions of the solenoid valve.

10. The system of claim 1, wherein the one or more irrigation controls comprise a pump, or a booster pump, or both.

11. The system of claim 10, wherein the functions of the irrigation controls comprise the timing and amount of water discharged through the pump and the booster pump.

12. The system of claim 1, wherein the system is operable across multiple agricultural zones.

13. The system of claim 12, wherein the clock comprises multiple channels corresponding to the agricultural zones.

14. The system of claim 12, wherein the relay signal repeaters are operatively disposed across the agricultural zones for transmitting the command signals through the mesh network to the irrigation controls.

15. The system of claim 1, further comprising a switch operatively connected to the one or more irrigation controls, the switch operable to receive the valve command signals, the switch operable to control the one or more irrigation controls in correspondence to the valve command signals.

16. The system of claim 1, wherein the mesh network includes at least one following networks: a Z-wave network, a Zigbee network, a packet radio network, a thread network, an Smash network, a SolarMESH project network, and a WiBACK wireless technology network.

17. A wireless irrigation clock system, the system comprising:
a clock comprising a housing having a display and multiple switches configured to receive input for an irrigation command, the irrigation command operable to control one or more functions of one or more irrigation controls,
the clock operable to generate one or more command signals based on the inputted irrigation command, the command signals operable to actuate the functions of the irrigation controls, the clock operable to transmit the command signals over a mesh network across multiple agricultural zones,
the housing further having a transreceiver, a real time clock, a microcontroller, and a circuitry, the transreceiver configured to receive and transmit the command signals, the real time clock configured to track both time and date,
the clock further comprising multiple channels corresponding to the agricultural zones;
multiple relay signal repeaters operable to carry the command signals across the mesh network; and
a switch operatively connected to the one or more irrigation controls, the switch operable to receive the valve command signals, the switch operable to control the one or more irrigation controls in correspondence to the valve command signals.

18. The system of claim 17, wherein the clock comprises multiple LED's having a unique illumination, each illumination indicating the status of a faulty or operational irrigation control.

19. The system of claim 17, wherein the mesh network includes at least one following networks: a Z-wave network, a Zigbee network, a packet radio network, a thread network, an Smash network, a SolarMESH project network, and a WiBACK wireless technology network.

20. A wireless irrigation clock system, the system consisting of:
a clock comprising a housing having a display and multiple switches configured to receive input for an irrigation command, the irrigation command operable to control one or more functions of one or more irrigation controls,
the clock operable to generate one or more command signals based on the inputted irrigation command, the command signals operable to actuate the functions of the irrigation controls, the clock operable to transmit the command signals over a mesh network across multiple agricultural zones, the mesh network including at least one following networks: a Z-wave network, a Zigbee network, a packet radio network, a thread network, an Smash network, a SolarMESH project network, and a WiBACK wireless technology network,
the housing further having a transreceiver, a real time clock, a microcontroller, and a circuitry, the transreceiver configured to receive and transmit the command signals, the real time clock configured to track both time and date,
the clock further comprising multiple channels corresponding to the agricultural zones,
the clock further comprising multiple LED's having a unique illumination, each illumination indicating the status of a faulty or operational irrigation control;
multiple relay signal repeaters operable to carry the command signals across the mesh network; and
a switch operatively connected to the one or more irrigation controls, the switch operable to receive the valve command signals, the switch operable to control the one or more irrigation controls in correspondence to the valve command signals.
